(19) United States
(12) Patent Application Publication
(10) Pub. No.: US 2025/0201873 A1
(43) Pub. Date: Jun. 19, 2025

(54) APPARATUS FOR COOLING A FUEL CELL STACK

(71) Applicants: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(72) Inventors: Hoyoung Jeong, Hwaseong-si (KR); Jae Yeon Kim, Hwaseong-si (KR); Yeong Jun Kim, Incheon (KR); Man Hee Park, Suwon-si (KR); Gwi Taek Kim, Cheonan-si (KR); Jeawan Kim, Hwaseong-si (KR); Yeonho Kim, Seoul (KR); Hochan An, Hwaseong-si (KR); Sung-Min Kim, Suwon-si (KR); Hong-Cheol Shin, Suwon-si (KR); Won-Woo Choi, Suwon-si (KR); Hyeong-Geun Kim, Suwon-si (KR); Hak Jun Lee, Suwon-si (KR); Jin-Young Kim, Suwon-si (KR); Seong-Jin Ahn, Suwon-si (KR); Seong-Hwan Bang, Suwon-si (KR); Si-Mok Park, Suwon-si (KR)

(73) Assignees: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(21) Appl. No.: 18/628,090

(22) Filed: Apr. 5, 2024

(30) Foreign Application Priority Data
Dec. 13, 2023 (KR) 10-2023-0181124

(51) Int. Cl. H01M 8/04029; B60H 1/00; H01M 8/0267; H01M 8/04007; H01M 8/04119

(52) U.S. Cl. CPC H01M 8/04029; B60H 1/00392; H01M 8/0267; H01M 8/04059; H01M 8/04164; H01M 2250/20

(57) ABSTRACT

An apparatus for cooling a fuel cell stack includes: a first refrigerant line through which a working fluid flows; a fuel cell stack provided in the first refrigerant line; a condenser provided in the first refrigerant line and disposed at a downstream side of the fuel cell stack; a pressure control valve provided in the first refrigerant line and disposed at a downstream side of the condenser; and a fluid pump provided in the first refrigerant line and disposed at a downstream side of the pressure control valve.

### CROSS-REFERENCE TO RELATED APPLICATION

This application claims priority to and the benefit of Korean Patent Application No. 10-2023-0181124 filed in the Korean Intellectual Property Office on Dec. 13, 2023, the entire contents of which are incorporated herein by reference.

### BACKGROUND OF THE DISCLOSURE

### (a) Technical Field

The disclosure relates to an apparatus for cooling a fuel cell stack.

### (b) Description of the Related Art

As interest in energy efficiency and problems of environmental pollution increase, there is a need for development of environmental-friendly vehicles that can substantially replace internal combustion engine vehicles. Generally, environmental-friendly vehicles are classified into electric vehicles, which operate using power generated by a fuel cell as a power source, and hybrid vehicles, which operate using an engine and a fuel cell.

An electric vehicle, which uses a fuel cell, generates driving power by converting chemical reactions into electrical energy. Specifically, an electric vehicle generates power using a chemical reaction between oxygen and hydrogen. In this process, because thermal energy is generated by a chemical reaction in a fuel cell, it is essential to effectively remove heat generated from the fuel cell, to ensure performance of the fuel cell.

As the target traveling performance and traction performance of a fuel cell electric vehicle are improved, the number of fuel cell stacks or a capacity of the fuel cell stack(s) is increase. Thus, the amount of heat generated from the fuel cell stack increases, which increases a cooling load.

Accordingly, there is a need to develop a new cooling system capable of efficiently cooling the fuel cell stack.

The above information disclosed in this Background section is provided only to enhance understanding of the background of the disclosure. Therefore, the Background section may contain information that is not part of the prior art that is already known to a person of ordinary skill in the art.

### SUMMARY OF THE DISCLOSURE

The present disclosure provides an apparatus for cooling a fuel cell stack, which is capable of improving performance in cooling a fuel cell stack and provides a vehicle including the same.

An apparatus for cooling a fuel cell stack according to an embodiment of the present disclosure may include: a first refrigerant line through which a working fluid flows, a fuel cell stack provided in the first refrigerant line; a condenser provided in the first refrigerant line and disposed at a downstream side of the fuel cell stack; a pressure control valve provided in the first refrigerant line and disposed at a downstream side of the condenser; and a fluid pump provided in the first refrigerant line and disposed at a downstream side of the pressure control valve.

In several embodiments, the apparatus may further include a reservoir tank provided in the first refrigerant line and disposed between the pressure control valve and the fluid pump.

In several embodiments, the apparatus may further include a connection line configured to branch off from the first refrigerant line between the fluid pump and the fuel cell stack and merge with the first refrigerant line between the fuel cell stack and the condenser. The apparatus may further include a first valve provided at a point at which the connection line branches off from the first refrigerant line; and a COD heater provided in the connection line.

In several embodiments, the apparatus may further include a second refrigerant line configured to branch off from the first refrigerant line between the first valve and the fuel cell stack and merge with the first refrigerant line between the condenser and the pressure control valve. The apparatus may further include a second valve provided at a point at which the second refrigerant line merges with the first refrigerant line; and a heater core provided in the second refrigerant line.

In several embodiments, the apparatus may further include an ion filter provided in the second refrigerant line and disposed at a downstream side of the heater core.

In several embodiments, the apparatus may include a first operation mode for cooling the fuel cell stack, a second operation mode for raising a temperature of the fuel cell stack, and a third operation mode for cooling the fuel cell stack and heating an interior of a vehicle.

In several embodiments, in the first operation mode, the first valve may operate to close a pathway between the first refrigerant line and the connection line, the second valve may operate to close a pathway between the first refrigerant line and the second refrigerant line, and the working fluid may sequentially circulate through the pressure control valve, the fluid pump, the fuel cell stack, and the condenser.

In several embodiments, in the second operation mode, the first valve may operate to connect the first refrigerant line and the connection line. The second valve may operate to close a pathway between the first refrigerant line and the second refrigerant line. The working fluid may sequentially circulate through the pressure control valve, the fluid pump, the COD heater, and the condenser.

In several embodiments, in the third operation mode, the first valve may operate to close a pathway between the first refrigerant line and the connection line. The second valve may operate to connect the first refrigerant line and the second refrigerant line. A part of the working fluid may sequentially circulate through the pressure control valve, the fluid pump, the fuel cell stack, and the condenser and a remaining part of the working fluid may sequentially circulate through the pressure control valve, the fluid pump, and the heater core.

In several embodiments, the apparatus may further include: a first temperature sensor configured to measure a temperature of the fuel cell stack; a second temperature sensor configured to measure an outside air temperature; and a controller configured to control a flow rate of the working fluid flowing along the first refrigerant line so that the working fluid in the fuel cell stack is evaporated only within a preset dryness range on the basis of the temperature of the fuel cell stack and the outside air temperature measured by the first and second temperature sensor.

In several embodiments, in the first mode or the third mode, the controller may control a pressure of the working fluid using the pressure control valve so that a phase change temperature of the working fluid is lower than the temperature of the fuel cell stack measured by the first temperature sensor and higher than the outside air temperature measured by the second temperature sensor.

In several embodiments, in the first mode or the third mode, the controller may control a pressure of the working fluid using the pressure control valve so that the amount of heat absorbed in the fuel cell stack is equal to the amount of heat dissipated from the condenser.

In several embodiments, in the second mode, the controller may control a flow rate of the working fluid flowing along the connection line using the fluid pump so that the working fluid in the COD heater is evaporated only within a preset dryness range.

A vehicle according to another embodiment may include the apparatus for cooling a fuel cell stack.

According to the embodiments, the pressure control valve may be disposed at the downstream side of the condenser. Thus, the working fluid having passed through the fuel cell stack may dissipate heat in the condenser while being kept in a high-pressure state, thereby increasing the maximum capacity for cooling the fuel cell stack.

Other effects, which may be obtained or expected by the embodiments of the present disclosure, are directly or implicitly disclosed in the detailed description of the present disclosure. In other words, various effects expected according to the present disclosure are disclosed in the following detailed description.

### BRIEF DESCRIPTION OF THE DRAWINGS

Because the drawings are provided for reference to describe embodiments of the present disclosure, the technical spirit of the present disclosure should not be construed as being limited to the accompanying drawings.

FIG. 1 is a block diagram illustrating a configuration of an apparatus for cooling a fuel cell stack according to an embodiment of the present disclosure.

FIGS. 2A and 2B are views illustrating a temperature distribution in a fuel cell stack according to an embodiment of the present disclosure.

FIG. 3 is a view illustrating an operating state of the apparatus in a first operation mode for cooling a fuel cell stack according to an embodiment of the present disclosure.

FIG. 4 is a view illustrating an operating state of the apparatus in a second operation mode for cooling a fuel cell stack according to an embodiment of the present disclosure.

FIG. 5 is a view illustrating an operating state of the apparatus in a third operation mode for cooling a fuel cell stack according to an embodiment of the present disclosure.

It should be understood that the accompanying drawings are not necessarily to scale, but instead provide a somewhat simplified representation of various features that exemplify the basic principles of the present disclosure. For example, specific design features of the present disclosure, including particular dimensions, directions, positions, and shapes, will be partially determined by the particularly intended application and use environment.

### DETAILED DESCRIPTION OF THE EMBODIMENTS

The terms used herein are merely for the purpose of describing specific embodiments of the present disclosure and are not intended to limit the present disclosure. The singular expressions used herein are intended to include the plural expressions unless the context clearly dictates otherwise. It is to be understood that the terms “comprise (include)” and/or “comprising (including)” used in the present specification mean that the features, the integers, the steps, the operations, the constituent elements, and/or component are present. However, the presence or addition of one or more of other features, integers, steps, operations, constituent elements, components, and/or groups thereof is not excluded by these terms. The term “and/or” used herein includes any one or all the combinations of listed related items.

The present disclosure is described in detail with reference to the accompanying drawings so that those having ordinary skill in the art to which the present disclosure pertains may easily carry out the embodiments. However, the embodiments of the present disclosure may be implemented in various different ways and the present disclosure is not limited to the embodiments described herein.

A detailed descriptions of parts or components determined to be unrelated or extraneous to the inventive concept described herein have been omitted in order to describe the present disclosure more clearly. The same or similar constituent elements are designated by the same reference numerals throughout the specification and drawings.

In addition, the size and thickness of each component illustrated in the drawings are arbitrarily shown for ease of description, and the present disclosure is not limited to the size and thickness of the components illustrated herein. In order to clearly illustrate and describe several portions and regions, thicknesses thereof may have been enlarged.

The suffixes ‘module’, ‘unit’, ‘part’, and/or ‘portion’ used to describe constituent elements in the following description are used together or interchangeably in order to facilitate the description, but the suffixes themselves do not have distinguishable meanings or functions.

In addition, in the description of the disclosed embodiments, specific descriptions of publicly known related technologies have been omitted where it has been determined that specific descriptions thereof may obscure the subject matter of the embodiment disclosed in the present specification.

In addition, it should be interpreted that the accompanying drawings are provided only to allow those having ordinary skill in the art to easily understand the embodiments disclosed in the present specification. The technical spirit or inventive concept disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms.

In the following description, the singular expression “one” or “single” may be interpreted as the singular or plural expression unless explicitly stated. These terms are used only to distinguish one constituent element from another constituent element.

When a component, device, element, or the like of the present disclosure is described as having a purpose or performing an operation, function, or the like, the component, device, or element should be considered herein as being “configured to” meet that purpose or perform that operation or function.

Hereinafter, an apparatus for cooling a fuel cell stack according to an embodiment of the present disclosure is described in detail with reference to the accompanying drawings.

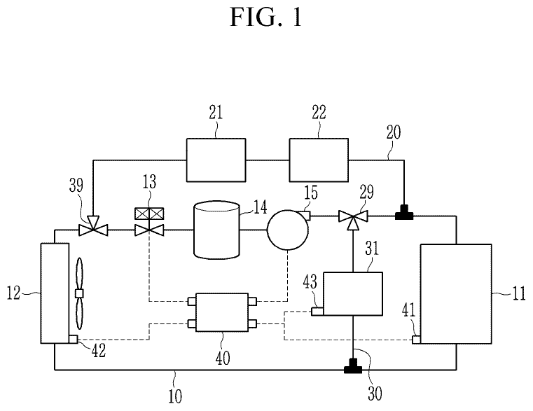

FIG. 1 is a block diagram illustrating a configuration of an apparatus for cooling a fuel cell stack according to an embodiment.

As illustrated in FIG. 1, the apparatus for cooling a fuel cell stack according to an embodiment may include a first refrigerant line 10 through which a working fluid flows, a fuel cell stack 11, a condenser 12, a pressure control valve 13, and a fluid pump 15 provided in the first refrigerant line 10.

The working fluid, which flows through the first refrigerant line 10, may be a two-phase fluid (or refrigerant) that changes phase depending on changes in temperature and/or pressure. The two-phase fluid (or refrigerant) according to one embodiment may be Novec™ 649.

In examples where a two-phase fluid (or refrigerant) is used as the working fluid, a convection heat transfer coefficient may be significantly improved by virtue of a mixing effect implemented by a difference in density between a liquid phase and a gas phase when the working fluid evaporates or condenses.

Further, when the two-phase fluid (or refrigerant) exchanges heat with a heat exchange object (e.g., the fuel cell stack 11) (e.g., when the two-phase fluid evaporates or condenses), a change in temperature of the two-phase fluid is minimized because of the phase change of the two-phase fluid. Accordingly, when the two-phase fluid exchanges heat with a heat exchange object a relatively large difference in temperature between the two-phase fluid and the heat exchange object may be maintained. In contrast, a single-phase fluid, such as a coolant, under goes a relatively large change in temperature during heat exchange, such that a there is a relatively small difference in temperature between the single-phase fluid and a heat exchange object.

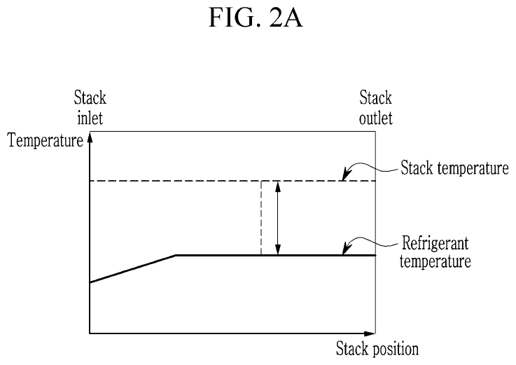

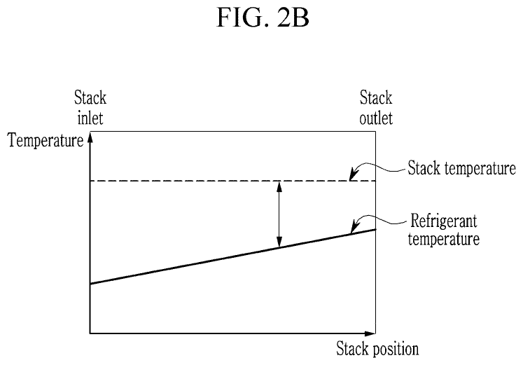

FIG. 2A is a view illustrating a temperature distribution in the fuel cell stack 11 when the working fluid is a two-phase fluid (e.g., refrigerant). FIG. 2B is a view illustrating a temperature distribution in the fuel cell stack 11 when the working fluid is a single-phase fluid (e.g., coolant).

With reference to FIG. 2A, during a heat absorption process in which the working fluid absorbs heat from the fuel cell stack 11, the working fluid absorbs heat from the fuel cell stack 11 while changing in phase from a liquid to a gas (e.g., the two-phase fluid), such that a relatively large difference in temperature between the fuel cell stack 11 and the working fluid is maintained.

With reference to FIG. 2B, during the heat absorption process in which the working fluid absorbs heat from the fuel cell stack 11, the temperature of the working fluid increases as the working fluid absorbs heat from the fuel cell stack 11. Therefore, there is a relatively small difference in temperature between the fuel cell stack 11 and the working fluid.

Because the two-phase fluid exchanges heat with the heat exchange object (the fuel cell stack 11) while maintaining a predetermined temperature as described above, the temperature distribution may be uniformly maintained in the fuel cell stack 11, and power generation efficiency of the fuel cell stack 11 may be improved.

The fuel cell stack 11 provided in the first refrigerant line 10 may generate power for driving the vehicle, by converting chemical reaction energy of oxygen and hydrogen into electrical energy.

The condenser 12 may be provided in the first refrigerant line 10 and disposed at a downstream side of the fuel cell stack 11. The condenser 12 may condense the working fluid by way of heat exchange between outside air and the working fluid.

The pressure control valve 13 may be provided in the first refrigerant line 10 and disposed at a downstream side of the condenser 12. The pressure control valve 13 may expand the working fluid flowing along the first refrigerant line 10 and adjust a temperature and pressure of the working fluid. The pressure control valve 13 may be an electronic pressure control valve 13 configured to selectively expand a refrigerant.

In the apparatus for cooling a fuel cell stack according to an embodiment, the pressure control valve 13 is disposed at the downstream side of the condenser 12, such that the working fluid having passed through the fuel cell stack 11 and the condenser 12 may be kept in a high-pressure state. Therefore, a difference in temperature between the working fluid and the outside air in the condenser 12 may be increased, and the heat dissipation performance of the condenser 12 may be improved. In addition, as the heat dissipation performance of the condenser 12 is improved, the performance in cooling the fuel cell stack 11 may be improved. In addition, when only the liquid refrigerant is supplied to the pressure control valve 13, the flow rate stability of the working fluid may be improved.

The fluid pump 15 may be provided in the first refrigerant line 10 and disposed at a downstream side of the pressure control valve 13. The fluid pump 15 may pump the working fluid flowing along the first refrigerant line 10 and circulate the working fluid through the first refrigerant line 10.

As necessary, a reservoir tank 14 may be provided in the first refrigerant line 10 and disposed between the pressure control valve 13 and the fluid pump 15. The reservoir tank 14 may temporarily store the working fluid and stably or steadily supply only the liquid refrigerant to the fluid pump 15.

The apparatus for cooling a fuel cell stack according to an embodiment may further include a connection line 30 configured to branch off from the first refrigerant line 10 between the fluid pump 15 and the fuel cell stack 11 and merge with the first refrigerant line 10 between the fuel cell stack 11 and the condenser 12. The apparatus for cooling a fuel cell stack may further include a first valve 29 provided at a point at which the connection line 30 branches off from the first refrigerant line 10, and a cathode oxygen depletion (COD) heater 31.

The first valve 29 may be installed between the fluid pump 15 and the fuel cell stack 11 and provided at the point at which the connection line 30 branches off from the first refrigerant line 10. The first valve 29 may be implemented as a three-way valve. In accordance with an operation of the first valve 29, the first refrigerant line 10 and the connection line 30 may be fluidly connected to each other, or the first refrigerant line 10 and the connection line 30 may be fluidly disconnected.

The COD heater 31 may generate heat from electrical energy generated by the fuel cell stack 11. For example, when the supply of the working fluid to the fuel cell stack 11 is cut off during a cold start of the fuel cell stack 11, a temperature of the fuel cell stack 11 is raised as the fuel cell stack 11 autonomously generates heat, and the electrical energy generated by the fuel cell stack 11 may be consumed by the COD heater 31. The heat generated by the COD heater 31 may be used to heat the interior of the vehicle or raise a temperature of the coolant in another cooling device in the vehicle.

The apparatus for cooling a fuel cell stack according to an embodiment may include a second refrigerant line 20 configured to branch off from the first refrigerant line 10 between the first valve 29 and the fuel cell stack 11 and merge with the first refrigerant line 10 between the condenser 12 and the pressure control valve 13. The apparatus for cooling a fuel cell stack may further include a second valve 39 provided at a point at which the second refrigerant line 20 merges with the first refrigerant line 10 and a heater core 22 provided in the second refrigerant line 20.

The second valve 39 may be installed between the condenser 12 and the fluid pump 15 and provided at the point at which the second refrigerant line 20 merges with the first refrigerant line 10. The second valve 39 may be implemented as a three-way valve (three-way valve). In accordance with an operation of the second valve 39, the first refrigerant line 10 and the second refrigerant line 20 may be fluidly connected to each other, or the first refrigerant line 10 and the second refrigerant line 20 may be fluidly disconnected.

The heater core 22 may heat the interior of the vehicle by way of heat exchange between the working fluid and air in the vehicle.

As necessary, an ion filter 21 may be provided in the second refrigerant line 20. The ion filter 21 may be disposed at a downstream side of the heater core 22. The ion filter 21 may reduce electrical conductivity of the working fluid by removing ions in the working fluid. As described above, the ion filter 21 may reduce the electrical conductivity of the working fluid, which may prevent the insulation resistance of the fuel cell stack 11 from being broken down or degraded.

The apparatus for cooling a fuel cell stack according to the embodiment may further include a first temperature sensor 41 configured to measure a temperature of the fuel cell stack 11, a second temperature sensor 42 configured to measure an outside air temperature, and a controller 40 configured to control operation of the pressure control valve 13 and operation of the fluid pump 15. The controller 40 may control operation of the pressure control valve 13 and operation of the fluid pump 15 on the basis of the temperature of the fuel cell stack 11 measured by the first temperature sensor 41 and the outside air temperature measured by the second temperature sensor 42.

Sensor data or information indicative of the temperature of the fuel cell stack 11 measured by the first temperature sensor 41 and the outside air temperature measured by the second temperature sensor 42 may be transferred or sent to the controller 40.

The controller 40 may control a pressure (or temperature) of the working fluid using the pressure control valve 13 and a flow rate of the working fluid by using the fluid pump 15 based on the temperature of the fuel cell stack 11 and the outside air temperature.

To this end, the controller 40 may be implemented as one or more processors operated by a preset program, and program instructions, which are programmed to perform steps of a method of cooling the fuel cell stack 11 according to the present disclosure using the one or more processors. The preset program, and program instructions, which are programmed to perform steps of a method of cooling the fuel cell stack may be stored in a memory of the controller.

Hereinafter, operation of the apparatus for cooling a fuel cell stack according to an embodiment is described in detail with reference to the accompanying drawings.

Operation modes of the apparatus for cooling a fuel cell stack according to the embodiment may include a first operation mode, a second operation mode, and a third operation mode.

The first operation mode may be an operation mode for cooling the fuel cell stack 11. The second operation mode may be an operation mode for raising a temperature of the fuel cell stack 11 during a cold start. The third operation mode may be an operation mode for cooling the fuel cell stack 11 and heating the interior of the vehicle.

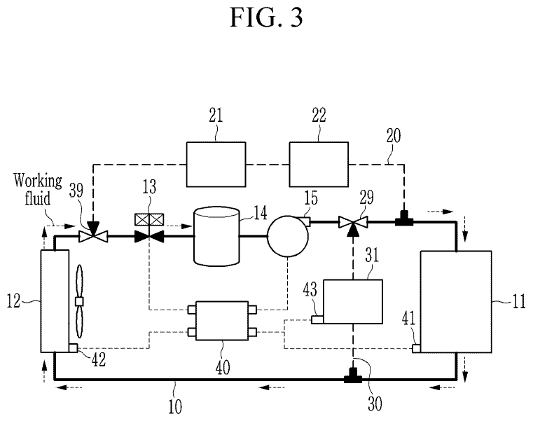

With reference to FIG. 3, in the first operation mode, the first valve 29 may operate to close the first refrigerant line 10 and the connection line 30, the second valve 39 may operate to close a connection or pathway between the first refrigerant line 10 and the second refrigerant line 20. In the first operation mode, the working fluid may sequentially circulate through the pressure control valve 13, the fluid pump 15, the fuel cell stack 11, and the condenser 12. In the first operation mode, the working fluid circulates only along the first refrigerant line 10.

Therefore, the working fluid heated in the fuel cell stack 11 may be condensed in the condenser 12 while dissipating heat, and the working fluid condensed in the condenser 12 may decrease in pressure by expanding while passing through the pressure control valve 13. The working fluid after being depressurized in the pressure control valve 13 may be pumped by the fluid pump 15, circulated along the first refrigerant line 10, and supplied to the fuel cell stack 11. Further, the working fluid introduced into the fuel cell stack 11 may absorb heat generated from the fuel cell stack 11 while exchanging heat with the fuel cell stack 11. The fuel cell stack 11 may be cooled by the above described process.

Because the condenser 12 is disposed at an upstream side of the pressure control valve 13, the working fluid passing through the fuel cell stack 11 may dissipate heat while being kept in a high-pressure state in the condenser 12 in the first operation mode. Therefore, the maximum capacity (or capacity for absorbing heat) for cooling the fuel cell stack 11 may be improved.

In the first operation mode, during the heat absorption process in which the heat generated from the fuel cell stack 11 is absorbed by the working fluid, the controller 40 controls a flow rate of the working fluid by controlling the fluid pump 15 on the basis of the temperature of the fuel cell stack 11 and the outside air temperature measured by the first temperature sensor 41 and the second temperature sensor 42. Therefore, the working fluid in the fuel cell stack 11 may be evaporated only within a preset dryness range (e.g., 0.4 to 0.6). Therefore, it is possible to prevent the working fluid from being overheated.

In the first operation mode, during a pressure control process in which the working fluid is expanded by the pressure control valve 13, the controller 40 may control a pressure (or temperature) of the working fluid. Thus, a phase change temperature of the working fluid, using the pressure control valve 13 so that a phase change temperature of the working fluid is lower than the temperature of the fuel cell stack 11 measured by the first temperature sensor 41 and higher than the outside air temperature measured by the second temperature sensor 42. Alternatively, during the pressure control process, the controller 40 may control the pressure of the working fluid by using the pressure control valve 13 so that a quantity of heat absorbed in the fuel cell stack 11 is equal to the amount of heat dissipated from the condenser 12. As described above, the pressure (or temperature) of the working fluid is controlled by the pressure control valve 13 based on an air temperature at the condenser 12 side that is a heat dissipation part. Therefore, liquid working fluid may be supplied to the pressure control valve 13, and stability of the flow rate of the working fluid to be supplied to the pressure control valve 13 may be ensured.

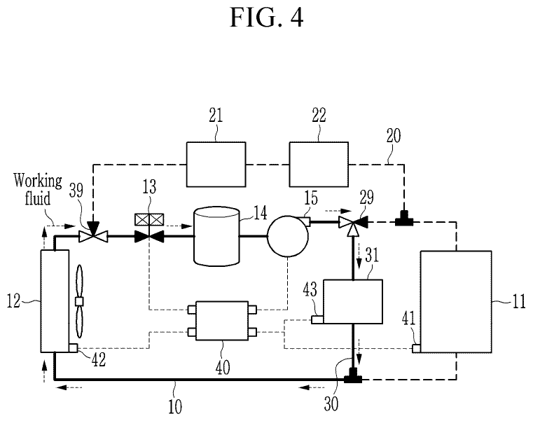

With reference to FIG. 4, in the second operation mode, the first valve 29 may operate to connect the first refrigerant line 10 and the connection line 30, the second valve 39 may operate to close the first refrigerant line 10 and the second refrigerant line 20, and the working fluid may sequentially circulate through the pressure control valve 13, the fluid pump 15, the COD heater 31, and the condenser 12. In the second operation mode, the working fluid circulates along the first refrigerant line 10 and the connection line 30.

Therefore, the working fluid, which is heated while passing through the COD heater 31, may be condensed in the condenser 12 while dissipating heat. The working fluid after having been condensed in the condenser 12 may be depressurized while passing through the pressure control valve 13. The working fluid after having been depressurized in the pressure control valve 13 may be pumped by the fluid pump 15, circulated through the first refrigerant line 10 and the connection line 30, and supplied to the COD heater 31. Further, the working fluid introduced into the COD heater 31 may absorb heat generated from the COD heater 31 while exchanging heat with the COD heater 31. Accordingly, the working fluid may be prevented from being supplied to the fuel cell stack 11 during the cold start. Thus, the fuel cell stack 11 increases in temperature while generating power and heat, and the electrical energy generated by the fuel cell stack 11 may be consumed by the COD heater 31. In other words, the COD heater 31 may generate heat by using the electrical energy generated by the fuel cell stack 11.

In the second operation mode, the working fluid passing through the COD heater 31 may dissipate heat while being kept in a high-pressure state in the condenser 12.

In the second operation mode, during the heat absorption process in which the heat generated by the COD heater 31 is absorbed by the working fluid, the controller 40 may control the flow rate and pressure of the working fluid by controlling the fluid pump 15 and the pressure control valve 13 on the basis of a temperature of the COD heater 31 measured by a third temperature sensor 43. Therefore, the working fluid in the COD heater 31 may be evaporated only within a preset dryness range (e.g., 0.4 to 0.6). Therefore, it is possible to prevent the working fluid from being overheated.

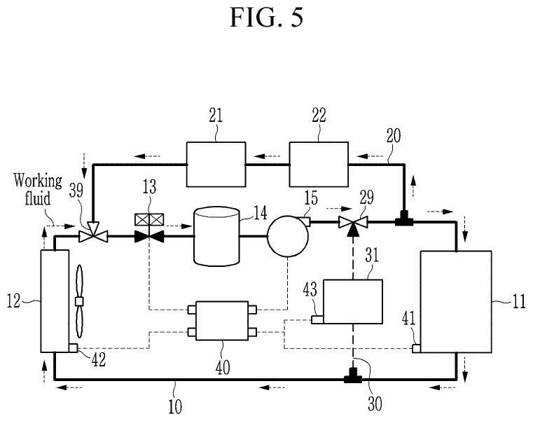

With reference to FIG. 5, in the third operation mode, the first valve 29 may operate to close a connection or pathway between the first refrigerant line and the connection line 30, the second valve 39 may operate to connect the first refrigerant line and the second refrigerant line 20. In the third operation mode, the working fluid may sequentially circulate through the pressure control valve 13, the fluid pump 15, the fuel cell stack 11, and the condenser 12. In addition, the working fluid may sequentially circulate through the pressure control valve 13, the fluid pump 15, the heater core 22, and the ion filter 21. In other words, the working fluid, which is depressurized in the pressure control valve 13 and pumped by the fluid pump 15, may flow to the fuel cell stack 11 and also flow to the heater core 22.

Therefore, the working fluid heated in the fuel cell stack 11 may dissipate heat while being condensed in the condenser 12. The working fluid after having been condensed in the condenser 12 may be depressurized by expanding while passing through the pressure control valve 13. The working fluid after having been depressurized in the pressure control valve 13 while expanding may be pumped by the fluid pump 15, circulated along the first refrigerant line 10, and supplied to the fuel cell stack 11. Further, the working fluid introduced into the fuel cell stack 11 may absorb heat generated from the fuel cell stack 11 while exchanging heat with the fuel cell stack 11. The fuel cell stack 11 may be cooled by the process described above.

At the same time, the working fluid, which is depressurized in the pressure control valve 13 and pumped by the fluid pump 15, may pass through the heater core 22 and the ion filter 21. The working fluid introduced into the heater core 22 may heat the interior of the vehicle while exchanging heat with air in the vehicle. The working fluid having passed through the heater core 22 may pass through the ion filter 21 and be supplied to the pressure control valve 13 through the second valve 39.

The process described above may cool the fuel cell stack 11 and heat the interior of the vehicle.

Because the condenser 12 is disposed at the upstream side of the pressure control valve 13, the working fluid passing through the fuel cell stack 11 may dissipate heat while being kept in a high-pressure state in the condenser 12 in the third operation mode. Therefore, a maximum capacity (or capacity for absorbing heat) for cooling the fuel cell stack 11 may be improved.

In the third operation mode, the working fluid cooled in the condenser 12 may be kept in a liquid state with a high temperature (e.g., 45 to 70 degrees Celsius) in accordance with an operational condition. Therefore, a part of the working fluid may be supplied to the heater core 22, which may heat the interior of the vehicle.

In the third operation mode, during the heat absorption process in which the heat generated from the fuel cell stack 11 is absorbed by the working fluid, the heat from the fuel cell stack 11 may be absorbed by way of a change in phase of the working fluid (from the liquid to the gas). Therefore, the heat transfer coefficient of the working fluid may be significantly improved in comparison with a single-phase coolant. In addition, because the phase change temperature of the working fluid may be maintained at a predetermined temperature during the heat absorption process, the difference in temperature between the working fluid and the fuel cell stack 11 may be maintained to be relatively large, thereby improving the temperature deviation of the fuel cell stack 11.

While embodiments of the present disclosure have been described above, the present disclosure is not limited thereto. Accordingly, various modifications can be made and carried out within the scope of the claims, the detailed description of the disclosure, and the accompanying drawings, and also fall within the scope of the disclosure.

### DESCRIPTION OF SYMBOLS

10: First refrigerant line
11: Fuel cell stack
12: Condenser
13: Pressure control valve
14: Reservoir tank
15: Fluid pump
20: Second refrigerant line
21: Ion filter
22: Heater core
29: First valve
30: Connection line
31: COD heater
39: Second valve
40: Controller
41: First temperature sensor
42: Second temperature sensor
43: Third temperature sensor

What is claimed is:

1. An apparatus for cooling a fuel cell stack, the apparatus comprising:
a first refrigerant line through which a working fluid flows;
a fuel cell stack provided in the first refrigerant line;
a condenser provided in the first refrigerant line and disposed at a downstream side of the fuel cell stack;
a pressure control valve provided in the first refrigerant line and disposed at a downstream side of the condenser; and
a fluid pump provided in the first refrigerant line and disposed at a downstream side of the pressure control valve.

2. The apparatus of claim 1, further comprising:
a reservoir tank provided in the first refrigerant line and disposed between the pressure control valve and the fluid pump.

3. The apparatus of claim 1, further comprising:
a connection line configured to branch off from the first refrigerant line between the fluid pump and the fuel cell stack and merge with the first refrigerant line between the fuel cell stack and the condenser;
a first valve provided at a point at which the connection line branches off from the first refrigerant line; and
a cathode oxygen depletion (COD) heater provided in the connection line.

4. The apparatus of claim 3, further comprising:
a second refrigerant line configured to branch off from the first refrigerant line between the first valve and the fuel cell stack and merge with the first refrigerant line between the condenser and the pressure control valve;
a second valve provided at a point at which the second refrigerant line merges with the first refrigerant line; and
a heater core provided in the second refrigerant line.

5. The apparatus of claim 4, further comprising:
an ion filter provided in the second refrigerant line and disposed at a downstream side of the heater core.

6. The apparatus of claim 4, wherein the apparatus comprises:
a first operation mode for cooling the fuel cell stack;
a second operation mode for raising a temperature of the fuel cell stack; and
a third operation mode for cooling the fuel cell stack and heating an interior of a vehicle.

7. The apparatus of claim 6, wherein, in the first operation mode:
the first valve operates to close a pathway between the first refrigerant line and the connection line;
the second valve operates to close a pathway between the first refrigerant line and the second refrigerant line; and
the working fluid sequentially circulates through the pressure control valve, the fluid pump, the fuel cell stack, and the condenser.

8. The apparatus of claim 6, wherein, in the second operation mode:
the first valve operates to connect the first refrigerant line and the connection line;
the second valve operates to close a pathway between the first refrigerant line and the second refrigerant line; and
the working fluid sequentially circulates through the pressure control valve, the fluid pump, the COD heater, and the condenser.

9. The apparatus of claim 6, wherein, in the third operation mode:
the first valve operates to close a pathway between the first refrigerant line and the connection line;
the second valve operates to connect the first refrigerant line and the second refrigerant line;
a part of the working fluid sequentially circulates through the pressure control valve, the fluid pump, the fuel cell stack, and the condenser; and
a remaining part of the working fluid sequentially circulates through the pressure control valve, the fluid pump, and the heater core.

10. The apparatus of claim 5, further comprising:
a first temperature sensor configured to measure a temperature of the fuel cell stack;
a second temperature sensor configured to measure an outside air temperature; and
a controller configured to control a flow rate of the working fluid flowing along the first refrigerant line so that the working fluid in the fuel cell stack is evaporated only within a preset dryness range on the basis of the temperature of the fuel cell stack and the outside air temperature measured by the first and second temperature sensor.

11. The apparatus of claim 10, wherein, in the first mode or the third mode, the controller controls a pressure of the working fluid using the pressure control valve so that a phase change temperature of the working fluid is lower than the temperature of the fuel cell stack measured by the first temperature sensor and higher than the outside air temperature measured by the second temperature sensor.

12. The apparatus of claim 10, wherein, in the first mode or the third mode, the controller controls a pressure of the working fluid using the pressure control valve so that the amount of heat absorbed in the fuel cell stack is equal to the amount of heat dissipated from the condenser.

13. The apparatus of claim 10, wherein, in the second mode, the controller controls a flow rate of the working fluid flowing along the connection line using the fluid pump so that the working fluid in the COD heater is evaporated only within a preset dryness range.

14. A vehicle comprising the apparatus for cooling a fuel cell stack according to claim 1.
